(19) United States
(12) Patent Application Publication
(10) Pub. No.: US 2013/0041688 A1
(43) Pub. Date: Feb. 14, 2013

(54) SYSTEM AND METHOD FOR DELIVERING HEALTHCARE ADVERTISEMENTS

(71) Applicants: Andre T. Vovan, Aliso Viejo, CA (US); Chris T. Vovan, Irvine, CA (US); William Allen Mincey, Irvine, CA (US); David Howard Glazov, Scottsdale, AZ (US)

(72) Inventors: Andre T. Vovan, Aliso Viejo, CA (US); Chris T. Vovan, Irvine, CA (US); William Allen Mincey, Irvine, CA (US); David Howard Glazov, Scottsdale, AZ (US)

(21) Appl. No.: 13/545,895

(22) Filed: Jul. 10, 2012

Related U.S. Application Data
(63) Continuation-in-part of application No. 12/015,703, filed on Jan. 17, 2008, now Pat. No. 8,239,215.
(60) Provisional application No. 60/885,375, filed on Jan. 17, 2007.

(51) Int. Cl. G06Q 50/24

(52) U.S. Cl. 705/3

(57) ABSTRACT

A system and method for healthcare advertisements and clinical messaging to healthcare consumers and physicians are disclosed herein.

### CROSS REFERENCES TO RELATED APPLICATIONS

This application is a continuation-in-part of U.S. patent application Ser. No. 12/015,703, filed Jan. 17, 2008, which claims the benefit of Provisional Application, Ser. No. 60/885,375, filed on Jan. 17, 2007, which are herein incorporated by reference.

### BACKGROUND OF THE INVENTION

1. Technical Field

The present invention relates to healthcare advertisements, and more specifically to an apparatus and method for effectively distributing revenues generated from delivering specific healthcare and non-healthcare advertisements over electronic medical record systems (EMR) and a regional healthcare information network (RHIN) using an electronic advertising server.

2. State of the Art

The current healthcare system is costly and inefficient. Adoption of electronic medical record systems is generally accepted as a means to increase efficiency, decrease duplication and decrease costs in healthcare delivery. A regional health information network is a collection of interconnected EMR systems that improves communication and transaction between healthcare providers (hospitals, physicians, etc.) and consumers. The current business model to sell EMR systems to physicians or other healthcare providers is based on the return on investment model. The overall cost of the EMR system is recouped by increased efficiency and effectiveness of the physician's practice using the EMR system over a period of time. A typical EMR business model consists of licensing the EMR software with or without hardware at an upfront cost and/or charging a yearly fee for software upgrades, maintenance and services. Additional services such as billing and practice management are also often offered. All revenue streams are derived from licensing the software and providing services to the purchasing physicians. These EMR systems are prohibitively costly for physician and are the biggest barrier of EMR adoption by the healthcare industry.

Furthermore, healthcare advertisement often does not reach the target audience because HIPAA laws forbid the usage of protected personal health information from being used for marketing without the direct informed consent of the consumer party. Interested advertising parties usually seek to deliver their advertisement to a specific audience. For example, drug manufacturers of diabetic medication would wish to target patients who have diabetes as well as the health care providers treating these patients. Furthermore, it is well known that there are certain diseases that are statistically related to each other because of a causative effect, a similar underlying pathology or other biological reasons. For instance, people with diabetes may also develop vascular disease, heart disease, obesity, kidney disease, and/or chronic pain. Therefore, companies that market medications treating heart disease or obesity would benefit from targeting these diabetic patients and the healthcare providers caring for these diabetic patients and potentially prescribing these medications as well.

The current EMR model is not only costly to physicians and other healthcare providers but also does not provide an effective means to allow physicians and consumers to receive information and advertisements on drugs that are specific to the health condition in a manner that protects the patients privacy compliant with HIPAA laws.

Accordingly, what is needed is a system and method for overcoming the foregoing deficiencies, and ensuring that consumers and physicians receive the appropriate healthcare information and advertisements on medication, medical device and healthcare services that are specific to their illness and/or treatment.

### SUMMARY OF THE INVENTION

The present invention broadly provides a system and method to effectively deliver specific healthcare advertisements over electronic medical record systems (EMR) and a regional healthcare information network (RHIN) using an electronic advertising server. The present system consists of several components including: (1) an internet or intranet based patient portal used by health consumers to communicate with their health care provider; (2) a protocol at the patient portal in which the health consumer may (a) grant consent for the usage of his/her de-identified health record for marketing or commercial purposes, (b) choose from a menu of possible advertisement categories to be generated or (c) choose to receive non-specific advertisements; (3) a protocol to de-identify the patients' health records and to encode the allowed health information for targeting by advertisers; (4) an ad server using one of the choices selected in step 2 to provide the appropriate protocol to distribute the advertisement on the patient portal; (5) an EMR system used by a physician to record the clinical and financial encounters with the healthcare consumer; (6) an ad server which distributes the appropriate advertisement on the EMR to the physician based on the physician's demographic data and/or clinical data of the healthcare consumer if consent is given by that healthcare consumer; (7) a RHIN which bridges the EMR systems and patient portals to create a healthcare network or community of physicians, healthcare consumers and other providers using this system; (8) a private secure access point for other healthcare providers; and (9) an advertisement targeting process in which advertisers will be allowed to choose from a menu of target driven choices to select the targeted consenting audience without revealing their protected personal health information.

Protected Health Information (PHI) is individually identifiable information (information that relates to the past or present health of an individual) that includes the following fields: names; geographic subdivisions smaller than a state, including street address, city, county, precinct, zip code, and their equivalent geocodes; dates directly related to an individual, including birth date, admission date, discharge date, date of death; telephone numbers; fax numbers; electronic mail addresses; social security numbers; medical record numbers; health plan beneficiary numbers; account numbers; certificate and/or license numbers; vehicle identifiers and serial numbers, including license plate numbers; device identifiers and serial numbers; Web Universal Resource Locators (URLs); Internet Protocol (IP) address numbers; biometric identifiers, including finger and voice prints; full face photographic images and any comparable images; and any other unique identifying number, characteristic, or code. Removal of these fields creates a presumption that the information is de-identified and thus no longer subject to the Privacy Regulation.

The above choices include targeting an audience currently using the services or product being advertised, an audience using substitute or complementary products or services being advertised, an audience with health conditions which increase their current or future risks for any health condition that may require the services or product being advertised. Using this information, a protocol will match the targeted audience with the available matching de-identified health consumers. The ad server then distributes the appropriate ad(s) to the health consumers using the patient portal and to the physician or other health provider using the EMR system.

The present invention allows two distinct embodiments not found in existing models. The first embodiment is a direct-to-consumer channel in which healthcare related advertisements can be specifically targeted to consumers by using their clinical information. This channel allows advertisers to specifically target consumers based on what medication they use, what illnesses they have, and what risk factors they have for developing an illness or condition by which the products are approved to treat. Advertisers can also target consumers based on their usage of a competitor's product or a complementary product or services. This is done in a manner that is consistent with current HIPAA laws in which the targeted audience consents to receiving the marketing media and the targeted audience's personal identifying data (name, social security number, address, birthdates, etc.) are not used.

The network also allows for a direct-to-physician channel in which advertisers can reach physicians treating healthcare consumers because healthcare consumer clinical data can be used for marketing purposes if consent is given by the consumer. If consent is not given by the consumer, then the physician will receive advertising based on his choice and/or his demographic information such as his medical specialty.

The present invention also allows healthcare providers to benefit from the revenues generated from non-healthcare advertising on the EMR systems. Revenue from healthcare advertisements of products or services covered by the federal or state healthcare programs cannot go to the physicians or healthcare providers using the EMR or the regional healthcare network due to anti-kickback laws. However, advertisement revenues from product or services that are not covered by federal or state healthcare programs can be shared with the healthcare provider using the electronic medical record, therefore, allowing physicians to benefit from these revenues.

### BRIEF DESCRIPTION OF THE DRAWINGS

Various features of this system and method, which are believed to be novel, are set forth with particularity in the appended claims. The present method may best be understood by reference to the following description, taken in connection with the accompanying drawings:

FIG. 1 is a diagram illustrating the advertising network over RHIN

FIG. 2 describes the process of encoding a patient's health record and an advertisement using the codes on the MIDT table.

FIG. 3 illustrates an MIDT table.

FIG. 4 illustrates how a CTP is generated.

FIG. 5 illustrates how an ATP is generated.

FIG. 6 describes the interaction between the central ad server and the local ad server.

FIG. 7 describes the process of permissive advertising.

FIG. 8 is a diagram of the revenue distribution model of the present system

### DETAILED DESCRIPTION OF THE DRAWINGS

The following detailed description is of the best presently contemplated mode of carrying out the present invention. This description is not to be taken in a limiting sense, but is made merely for the purpose of illustrating general principles of embodiments of the present invention. The scope of the present invention is best defined by the appended claims.

In one embodiment, a system and method for effectively delivering specific healthcare advertisements over electronic medical record systems (EMR) and a regional healthcare information network (RHIN) using an electronic advertising server are disclosed herein.

In another embodiment, a system and method for effectively delivering specific healthcare advertisements to a healthcare consumer or physician are disclosed herein. It is appreciated that healthcare advertisements may be targeted advertisements but may also include clinical messaging or other educational materials. In other words, the advertisements may not only be advertising but also include clinical information relevant to a condition, symptom, disease, medication, indications for medication, contraindications for medication, or any combination thereof. Alternatively, clinical messaging or educational materials may be sent independent from or in lieu of targeted advertisements distributed by the system.

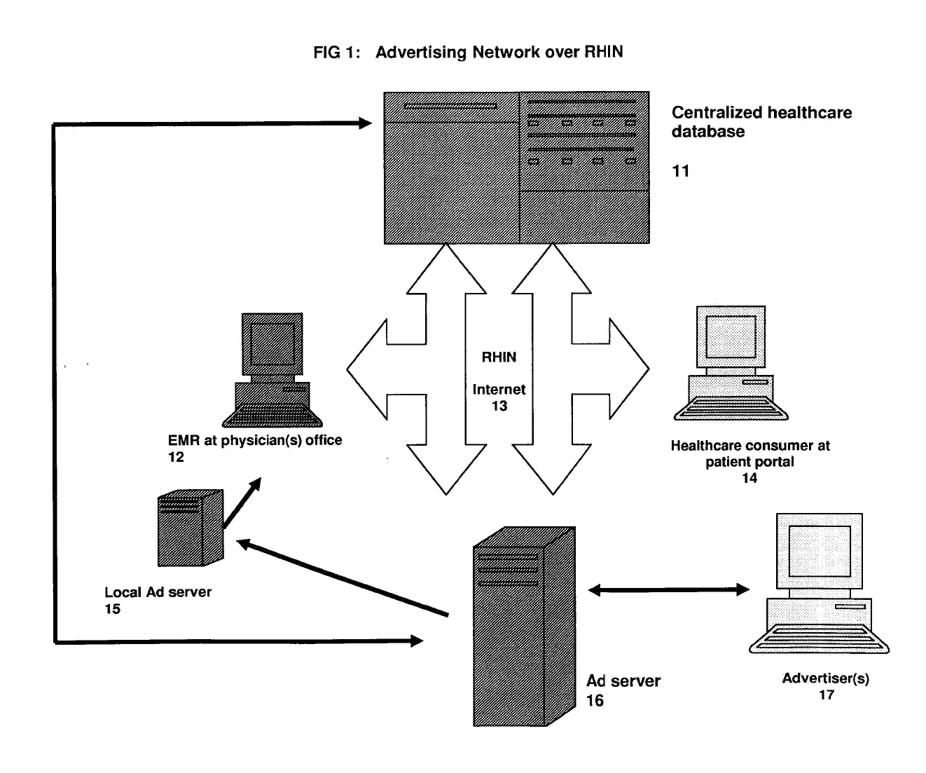

FIG. 1 describes the general relationship between the Centralized healthcare data base 11, the EMR system 12, the regional healthcare information network 13, and the central ad server 16, and the patient portal 14. The centralized healthcare database 11 hold general medical clinical information collected from both the electronic medical record 12 and the healthcare consumer patient portal 14. The centralized healthcare database 11 interacts with the EMR 12 and the healthcare consumer patient portal 14 via a secured regional healthcare information network (RHIN) internet linkage 13.

The EMR system 12 at the physician's office is an electronic medical records systems housing clinical data of individual healthcare consumers. This information can exist via a local software application at the healthcare service site or can be hosted by an application service provider. The EMR 12 captures relevant clinical encounter data between the healthcare consumers and the treating physicians or other healthcare providers. The EMR 12 application is used by physicians and other healthcare providers to document the patient's conditions and progressions of their treatment and capture and bill consumers for the services rendered. The EMR 12 essentially replaces the paper charts and allows physicians electronic access to the patient's disease courses, medical history and current symptoms. It also allows the physicians on the RHIN network 13 to electronically communicate with other physicians, payers, other healthcare facilities as well as health insurers on the network. The EMR 12 is essentially the physician's portal into the present regional healthcare information network (RHIN 13). The information that is entered into the physician's EMR systems 12 can be held locally at a local healthcare database, replicated, or held centrally at a centralized healthcare database 11.

The patient portal 14 in the system is an internet website portal allowing healthcare consumers to communicate with their treating physicians. At the patient portal 14 healthcare consumers may view their personal healthcare records. Patients may also choose to perform various functions including receiving notifications from their physician's office as well as request medications, refills, and/or schedule doctor's appointments. The patients also can attain or search for healthcare information at this web portal 14. Information entered into the patient portal 14 is stored at the centralized healthcare database 11 and is shared with the physicians at his EMR system 12. The component that allows patients and physicians to communicate to each other is the regional healthcare information network 13 (a secured internet linkage protocol).

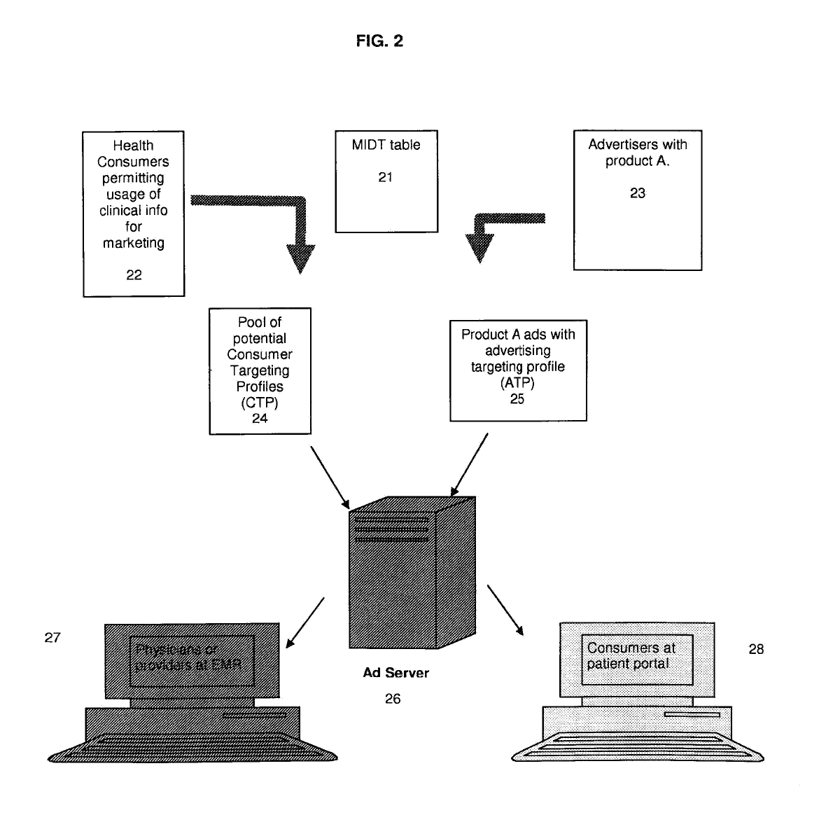

The regional healthcare information network 13 is an application which connects the EMR system 12 via a secure standard electronic communication protocol. The RHIN 13 acts as a bridge between the EMR systems 12 and the patient portal 14. The central ad server 16 is a an electronic system that uses the clinical information stored in the centralized healthcare database 11 or local database and the healthcare information of the healthcare consumer as a reference method to deliver appropriate advertisements to consumers and healthcare providers. The central ad server 16 directs specific advertisements to the healthcare consumers at the patient portal 14 and to physicians at the EMR office 12. The central ad server 16 may deliver advertisements to the physicians directly to the EMR office 12 from the centralized location, or the central ad server 16 may send the advertisements to a local ad server 15 located at the physicians' office or other healthcare providers facilities. The local ad server 15 will then deliver the advertisement to the user of the EMR 12. The central ad server 16 acts as a distributor for the advertisers who wish to distribute their advertisements to healthcare consumers and providers. Advertisers may load their advertisements onto the central ad servers 16 and designate where they wish those advertisements to be delivered. Alternatively, the system can call for advertisements at remote servers (e.g., third party servers) rather than hosting and storing such advertisements. FIG. 2 describes the process of encoding a patient's health record and an advertisement using the codes on the MIDT table. Healthcare consumers at the patient portal first grants permission for the use their clinical data (which includes their medication profile as well as their disease profile) to be used for marketing purposes 22. The consumers' medication and illness information is then encoded using a Medication, Illness, and Disease Table (MIDT) 21 which holds the codes for different medications and illnesses and how they are related to each other. The codes are used to generate a consumer targeting profile (CTP) 24 for each consenting consumer. The CTP 24 is a numeric representation of the consumer's medical information.

Advertisers 23 then use the information on MIDT table 21 to assign an advertising targeting profile (ATP) 25 to each advertisement. The ATP 25 is a numeric representation of the information contained in such advertisement.

The CTPs 24 and ATPs 25 are sent to the central ad server 26 where they are matched. The central ad server 26 then sends the appropriate advertisements to consumers at the patient portal 28 and their treating physicians at the EMR office 27 based on these CTP and ATP matches.

In another embodiment, the system includes a health information database, wherein health information is numerically or alphanumerically coded. The numeric and/or alphanumeric codes are used to identify demographic information of the patient and/or physician, physician specialty, physician subspecialty, medications, illness, diseases, genetic testing results, laboratory results, radiology results and/or reports. The system also includes an Internet portal accessible by a healthcare consumer or physician. The Internet portal includes a protocol that allows a healthcare consumer to give consent to release health information in a manner compliant with HIPPA. Additionally, the protocol allows a physician or patient to opt-in to receive advertisements, clinical messages, and/or educational materials. The system also includes an advertisement server that distributes advertisements, clinical messages, or educational materials based on the health information.

In one embodiment, the system includes a dedicated advertisement server that allows parties to upload advertisements. In another embodiment, the system is in communication with third party servers and databases. In this embodiment, the system obtains information in “real time” from these third party servers and databases that is presented to the healthcare consumer and/or physician. In yet another embodiment, the system includes both its own dedicated advertising portal as well as access to third party servers and databases.

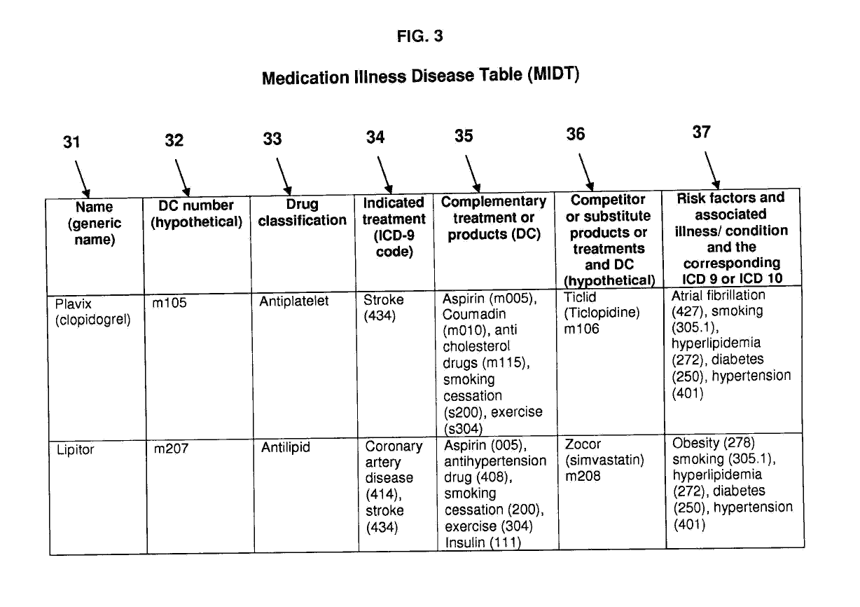

FIG. 3 displays the Medication, Illness and Disease Table (MIDT) in detail. The Medication, Illness and Disease Table puts different types of medications, illnesses, and diseases into categories based upon several factors including classifications and indicated treatment of the each medication, direct competitors or substitute products, risk factors, and associated illnesses that may increase by using such medications.

The first column 31 contains the name and the generic name of the drug or medical device, e.g., Plavix and Lipitor. The second column 32 is the corresponding drug or device code. For instance, the hypothetical device codes, m105 and m207, may represent Plavix and Lipitor, respectively. The device coding system 32 can be based on the national drug code (NDC) or any drug coding system. The third column 33 contains the drug classification or device classification. For example, Plavix, is classified as an antiplatelet drug and Lipitor is an anti-lipid drug. The fourth column 34 describes the disease the drug is approved to treat. Each disease is represented by the International Classification of Disease 9th iteration code (ICD-9) or any later iterations. However, other disease coding systems may also be used including SNOMED.

The fifth column 35 describes the complementary treatment or products which are often used to co-treat the illness that the medication is used. Complementary treatment or product are not direct competitors of the medication in question but are generally used to co-treat the same illness. For instance, complementary treatment and product such as aspirin, coumadin, cholesterol medications, smoking cessation services, as well as exercise, are recommended to be used with Plavix to co-treat stroke. Therefore, manufacturers of Plavix and Aspirin can target patients with stroke in marketing their products.

The sixth column 36 lists the competitor or substitute product or treatment for the medication in question. For instance, the medication Ticlid, which is approved to treat strokes, is a direct competitor of Plavix. This information allows advertisers to target not only consumers who use their products but also consumers who use their competitors' products. The last column 37 identifies the risk factors or associated illnesses of the drug or product in question. For example, the conditions of atrial fibrillation, smoking, hyperlipidemia, diabetes, and hypertension can increase the likelihood of strokes, the condition which can be treated using Plavix. Therefore, advertisers can target potential audience who are at risk of having certain health conditions which predisposed them to using the product or treatment in question.

In another embodiment, numeric and/or alphanumeric codes are used to identify demographic information of the patient and/or physician, physician specialty, physician subspecialty, medications, illness, diseases, genetic testing results, laboratory results, radiology results and/or reports. For one or more of the above-listed categories, the codified information may also be codified or associated with complementary treatments, complementary products, competitor products, substitute products, substitute treatments, alternative products, alternative treatments, or risk factors for associated illness or conditions.

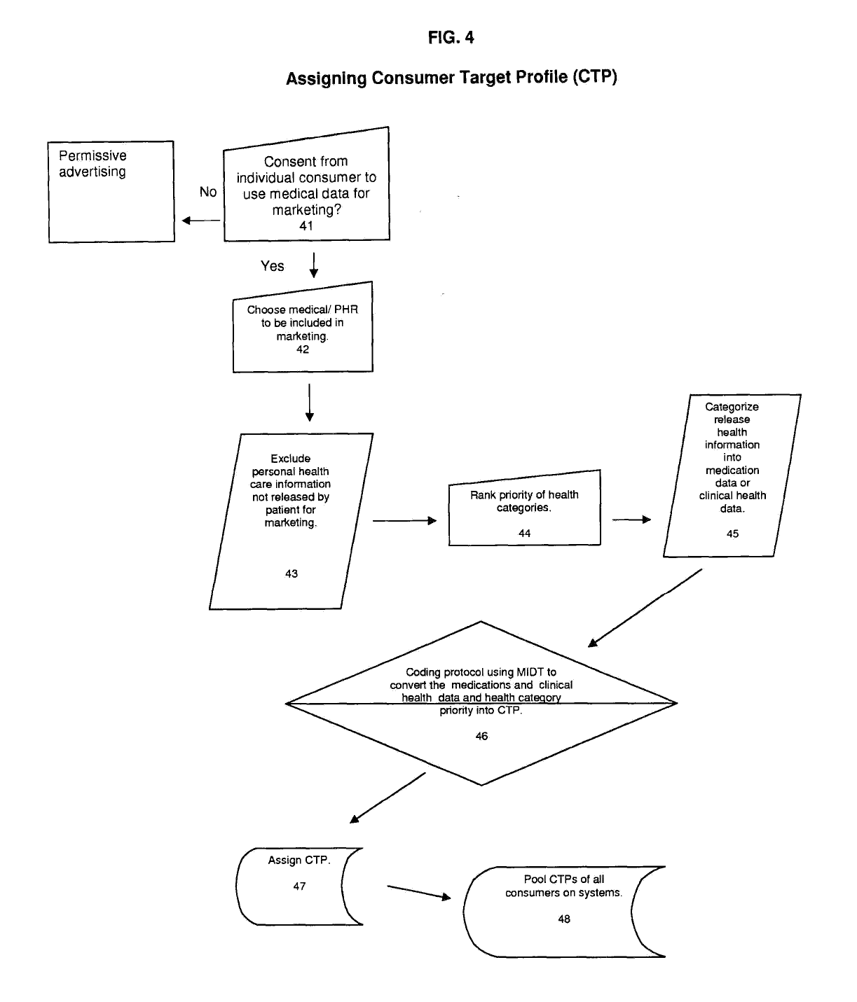

FIG. 4 illustrates the process of how a consumer targeting profile is created after health consumer consents to have his/her clinical data used for marketing. The healthcare consumer at the patient portal is first prompted to give consent 41 to have his clinical information be used for advertising. If the consumer gives consent, the consumer is then prompted to choose which aspect of his/her private health records may be used for marketing 42. The consumer may have his entire medical records or only a certain portion of his medical records be released for marketing. Any patient information or health conditions not released will be excluded 43. The consumer's personal identifying information as required by HIPAA Law to be deemed de-identified will also be excluded (i.e., name, social security number, address) 43.

The system then asks the consumer to rank the importance of his/her health issues or medications 44. This process of prioritizing allows advertisers to prioritize theirs advertisements for a particular consumer according to that consumer's priority.

The released clinical data is analyzed by the system and categorized into medication data and clinical healthcare data 45 which represent the consumer's health profile. The medication and clinical healthcare data are then converted into numeric codes 46 retrieved from the MIDT described in FIG. 3. These encoded medication and healthcare data then generate the consumer's assigned consumer targeted profile (CTP) 48. Therefore, each consenting consumer will have an assigned CTP. Theoretically, multiple consenting consumers may have identical CTPs.

The system stores all the assigned CTPs of all the consumers in network and makes them available to the network's advertisers 48 in order to allow advertisers to target their advertisements to certain consumer based on that consumer's CTP. This process allows the advertisers to specifically target the intended audience but does not allow the advertisers to know the specific identity of each targeted audience member which is in accordance to the HIPAA law.

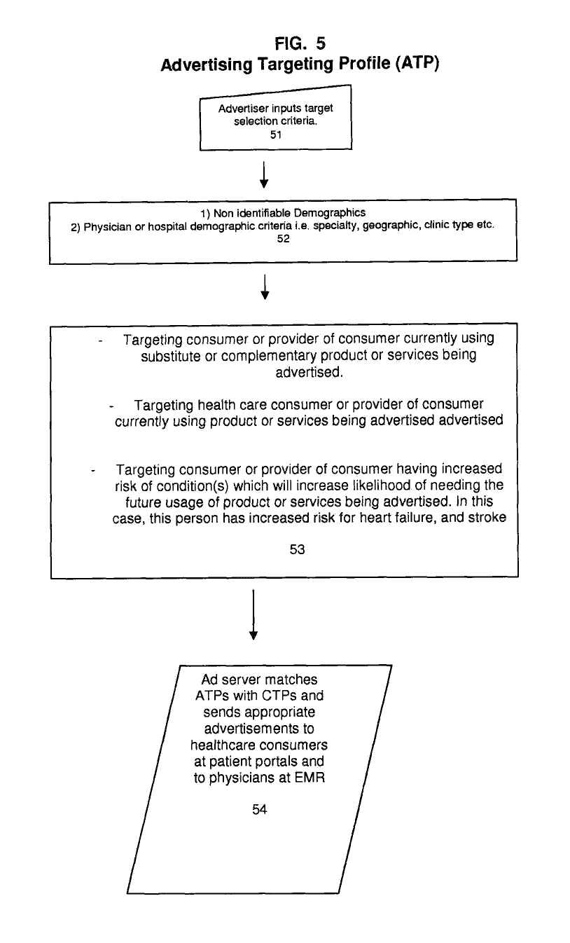

FIG. 5 illustrates the process of creating an advertising targeting profile (ATP) for a particular advertisement. The advertisers first input target criteria 51 which includes information regarding the products that they wish to advertise in the network. The advertisers can then choose to send their advertisements to consumer and healthcare providers based on non-identifiable demographics or physicians/hospital demographics (i.e., physician's specialty, geographic, etc.) 52. If advertisers wish to target a more specific group of consumers and/or providers 53, they may use the MIDT table to specify which group of consumers and/or providers they wish to receive their advertisements. The MIDT table allows advertisers to target many different healthcare consumers and providers including consumers who are currently using their medications, who have the indicated conditions for the product being advertised, who are using complementary products to the product being advertised, who are using a product that is a direct competitor of the product being advertised, and who have associated or risk factors for the condition which his product is approved to use for treatment. Similarly, the MIDT table allow the advertisers to target health care providers who are treating consumers who are currently using their medications, who have the indicated conditions for the product being advertised, who are using complementary products to the product being advertised, who are using a product that is a direct competitor of the product being advertised, and who have associated or risk factors for the condition which his product is approved to use for treatment.

Each advertisement is then assigned an ATP based on the advertiser's above selection. The central ad server matches the advertisements' ATPs with the consumers' CTPs and delivers these advertisements to the appropriate consumers at the patient portal and physicians at the EMR when a match is found 54.

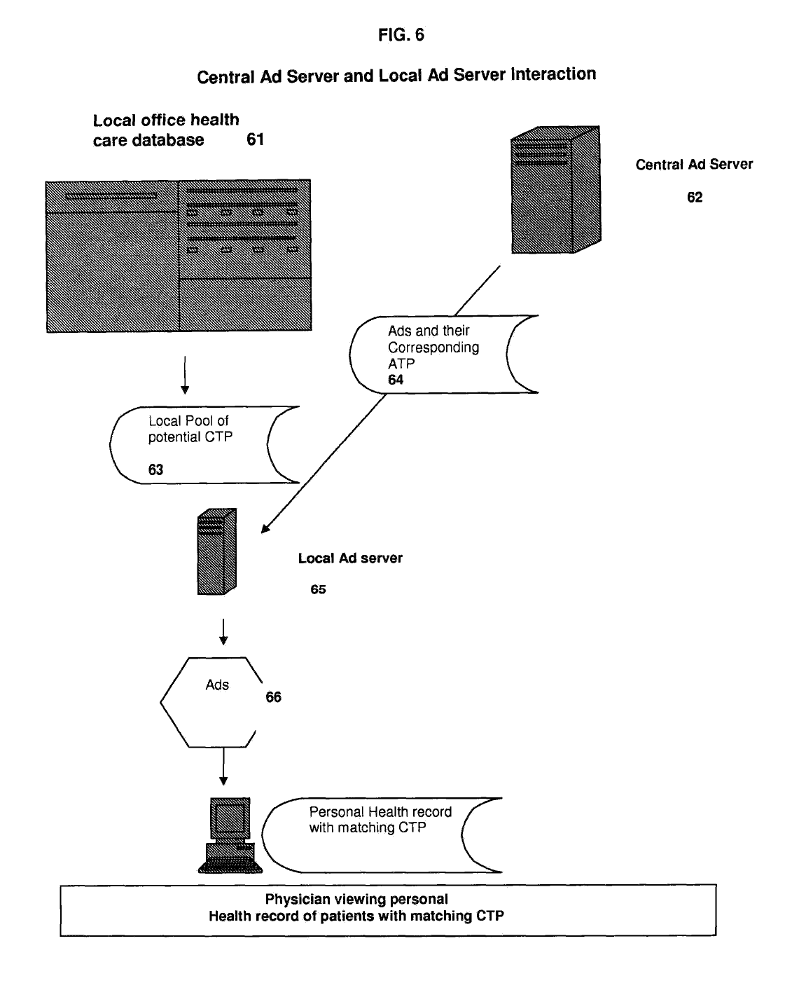

FIG. 6 describes another way that advertisements may be distributed to physicians or healthcare providers. If a physician or healthcare provider houses a local healthcare database at their office 61, a local ad server 65 can be placed at the respective facility or office.

A central ad server 62 sends advertisements and their corresponding APT codes 64 to a local ad server 65. The advertisements are held locally at the local ad server 65, which then matches the ATPs with the available local pool of potential CTPs 63 located in the local healthcare database 61. The local ad server then delivers the appropriate advertisements to the physicians at the EMR according to the ATP/CTP match 66.

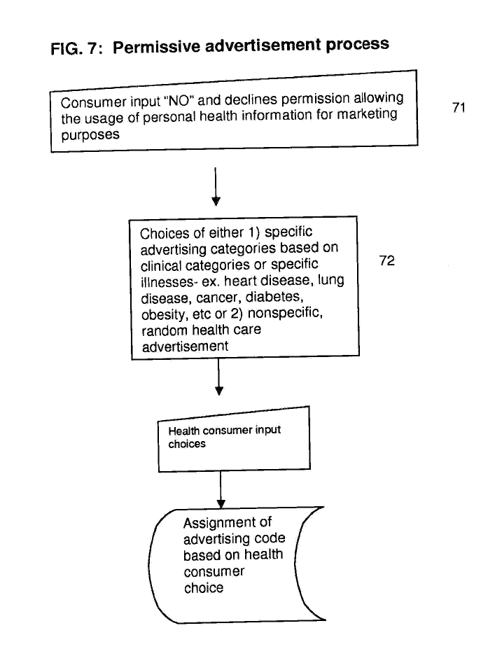

FIG. 7 illustrates the process of permissive advertising. When a consumer declines to give his consent to release his medical records for marketing 71, the system then gives the consumer a choice of receiving various advertisements that may be of interest to the consumer 72. The consumer may choose to have certain categories of health advertising to be shown to him directly because of his general interest. For instance, he/she may be asked if he/she is interested in receiving advertisements for products related to heart disease, lung disease, cancer, or other illnesses. If the consumer chooses to view any of these advertisements, then the central ad server delivers such advertisements to the consumer at the patient portal.

If the consumer does not have a preference of what type of advertisements he/she wishes to receive, then the central ad server sends non-specific, random healthcare and non-healthcare advertisements to him/her at the patient portal.

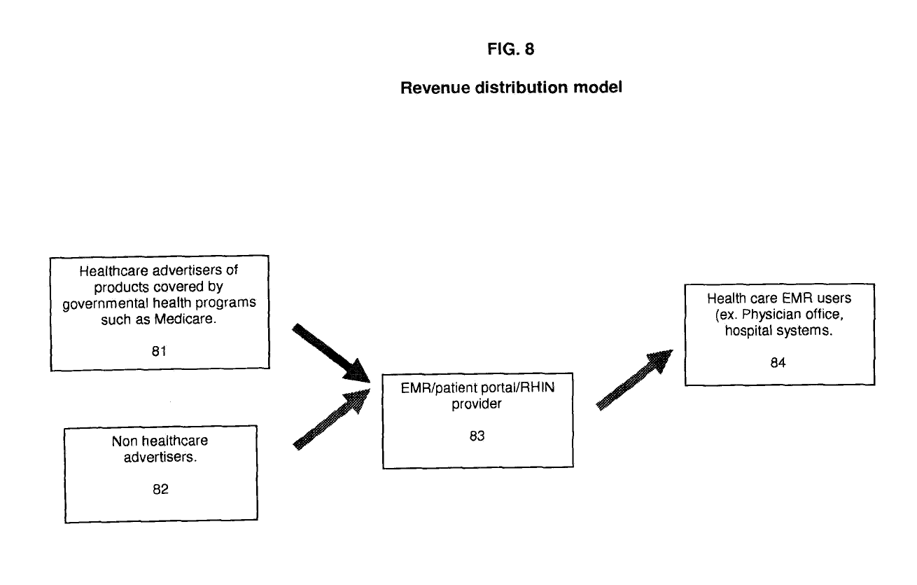

FIG. 8 illustrates the revenue distribution model of the present method and system. Revenues generating from healthcare advertisements of products covered by Federal Healthcare Programs such as Medicare 81 are prohibited by anti-kickback laws from flowing to healthcare providers who employ the EMR system. This revenue stays with the EMR, patient portal or RHIN providers 83. Anti-kickback law prevents physicians who are owners of the EMR systems to directly receive revenue from advertisers of pharmaceutical or medical products. Revenues generated from non-healthcare advertisements 82, on the other hand, are not under the jurisdiction of the anti-kickback law, therefore, may be shared with healthcare providers at the EMR 84.

Consequently, the revenue distribution model of the present invention effectively allows EMR users such as physicians at the EMR office to generate revenues from non-healthcare advertisements.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

What is claimed:

1. A clinical messaging system, comprising:
a healthcare database, wherein health information is alphanumerically or numerically coded;
an Internet portal;
a protocol at the Internet portal, wherein the protocol allows a healthcare consumer or a physician to choose to give consent to release health information; and
a messaging server, wherein the messaging server distributes clinically-relevant information based on the released health information.

2. The clinical messaging system of claim 1, wherein the health information is demographics, medication, illness, disease, laboratory results, or radiology reports.

3. The clinical messaging system of claim 1, wherein the protocol at the Internet portal allows the healthcare consumer or physician to prioritize different health issues.

4. The clinical messaging system of claim 1, wherein the clinically-relevant information is distributed based on health information including conditions matching a Federal Food and Drug Administration (FDA) approved usage of a product or services being provided.

5. The clinical messaging system of claim 1, wherein the clinically-relevant information is distributed based on health information including complementary products or services to a product or services being provided.

6. The clinical messaging system of claim 1, wherein the clinically-relevant information is distributed based on health information including products or services that are a direct competitor of a product or service being provided.

7. The clinical messaging system of claim 1, wherein the clinically-relevant information is distributed based on an associated illness or risk factors for a condition which a product or services are approved to use for treatment.

8. The clinical messaging system of claim 1, wherein the protocol at the Internet portal gives the healthcare consumer or physician the ability to view clinically-relevant messages from various categories selected by the healthcare consumer or physician if the healthcare consumer or physician declines to give consent to release health information.

9. The clinical messaging system of claim 1, wherein the messaging server presents non-specific, random health related or non-health related advertisements at the Internet portal if the healthcare consumer does not have a preference for any health information.

10. An electronic healthcare messaging system, comprising:
a healthcare database, wherein health information is encoded using alphanumeric or numeric codes, wherein the codes represent demographics, medication, illness, disease, laboratory results, and radiology results;
an Internet portal having a protocol, wherein the protocol allows a user to manage different health issues; and
a messaging server, wherein the messaging server distributes clinically-relevant information based on the health issues managed by the user.

11. The electronic healthcare messaging system of claim 10, wherein the protocol at the Internet portal allows the user to choose to give consent to release health information.

12. The electronic healthcare messaging system of claim 10, wherein the protocol at the Internet portal allows the user to prioritize different health issues.

13. The electronic healthcare messaging system of claim 10, wherein the clinically-relevant information is distributed based on the health issues matching a Federal Food and Drug Administration (FDA) approved usage of a product or services being prescribed.

14. The electronic healthcare messaging system of claim 10, wherein the clinically-relevant information is distributed based on the health issues related to complementary products or services to a product or services being prescribed.

15. The electronic healthcare messaging system of claim 10, wherein the clinically-relevant information is distributed based on health issues related to products or services that are a direct competitor of a product or service being prescribed.

16. The electronic healthcare messaging system of claim 10, wherein the clinically-relevant information is distributed based on queried health issues related to an associated illness or risk factors for a condition which a product or services are approved to use for treatment.

17. The electronic healthcare messaging system of claim 10, wherein the protocol at the Internet portal gives the user the ability to receive health related advertisements from various categories selected by the user if the user declines to give consent to release health information.

18. The electronic healthcare messaging system of claim 10, wherein the messaging server sends non-specific, random health related or non-health related advertisements to the user if the user has not provided any preference for any advertisements from the categories.

19. A method for delivering targeted clinical messages, the method comprising:
encoding health-related information using alphanumeric and numeric codes for medication data or clinical health data; and
delivering a targeted clinical message based on the numeric codes over Internet.

20. The method of claim 19, wherein the targeted clinical message is an advertisement.

21. The method of claim 19, wherein the targeted clinical message is delivered to a physician.

22. The method of claim 19, wherein the targeted clinical message is delivered to a healthcare consumer.

23. The method of claim 19, further comprising receiving consent from a health care consumer to release health information.

24. The method of claim 19, further comprising:
receiving prioritization of different health issues by a physician or a
healthcare consumer; and
delivering the targeted clinical message based on the numeric codes and the prioritization of different health issues by the physician or the healthcare consumer.

25. A method for delivering targeted clinical messages, the method comprising:
encoding health information using alphanumeric and numeric codes for medication data or clinical health data;
receiving consent from a physician to release healthcare information; and
delivering a targeted clinical message based on the alphanumeric or numeric codes related to the released healthcare information.

26. The method of claim 25, further comprising:
receiving prioritization of different health issues by the physician; and
delivering the advertisement based on the prioritization of different health issues by the physician.

27. A method for delivering targeted healthcare messages, the method comprising:
encoding health information using alphanumeric or numeric codes for medication data or clinical health data;
receiving prioritization of different health issues from a user; and
delivering a targeted healthcare message based on the alphanumeric or numeric codes and the prioritization of different health issues by the user.

28. The method of claim 27, wherein the user is a healthcare consumer.

29. The method of claim 28, further comprising:
receiving healthcare consumer consent to release health record information for marketing purposes.

30. The method of claim 27, wherein the targeted clinical message is an advertisement.

31. The method of claim 27, wherein the health information is demographics, medication, illness, disease, laboratory results, or radiology reports.
